(19) United States
(12) Patent Application Publication
(10) Pub. No.: US 2024/0332851 A1
(43) Pub. Date: Oct. 3, 2024

(54) MODULAR ELECTRONIC CONTROL UNIT HOUSING SYSTEM

(71) Applicants: DENSO International America, Inc., Southfield, MI (US); DENSO CORPORATION, Kariya-city (JP)

(72) Inventor: Justin HARRIS, Southfield, MI (US)

(73) Assignees: DENSO international America, Inc,, Southfield, MI (US); DENSO CORPORATION, Kariya-city (JP)

(21) Appl. No.: 18/438,042

(22) Filed: Feb. 9, 2024

Related U.S. Application Data
(60) Provisional application No. 63/492,268, filed on Mar. 27, 2023.

(51) Int. Cl. H01R 13/514; H01R 12/71; H01R 13/04; H01R 13/508

(52) U.S. Cl. CPC H01R 13/514; H01R 12/716; H01R 13/04; H01R 13/508

(57) ABSTRACT

A system for housing a circuit board including pin connectors. The system includes a case configured to cover the circuit board. The case defines an opening arranged to permit access to the pin connectors of the circuit board and includes a case coupling interface at the opening. A connector housing includes a pin interface configured to receive the pin connectors of the circuit board and a connector housing coupling interface configured to cooperate with the case coupling interface to secure the connector housing to the case over the opening and in cooperation with the pin connectors.

### CROSS-REFERENCE TO RELATED APPLICATION

This application claims the benefit of U.S. Provisional Application No. 63/492,268 filed on Mar. 27, 2023, the entire disclosure of which is incorporated herein by reference.

### FIELD

The present disclosure relates to a case for a circuit board, and connector housings each configured to couple to the case and cooperate with various pin arrangements of the circuit board.

### BACKGROUND

This section provides background information related to the present disclosure, which is not necessarily prior art.

A printed circuit board (PCB) is a flat, rigid substrate typically made of fiberglass or other insulating materials, upon which electronic components are mounted and interconnected. The PCB features a complex network of copper traces that serve as pathways for the flow of electrical signals between the components. Connector pins are metal terminals attached to the circuit board, providing points for external connections. These pins allow the circuit board to interface with other electronic devices, facilitating the transfer of data, power, or signals. The arrangement and design of the connector pins ensures proper connectivity and functionality within electronic systems.

### SUMMARY

This section provides a general summary of the disclosure, and is not a comprehensive disclosure of its full scope or all of its features.

The present disclosure includes a system for housing a circuit board including pin connectors. The system includes a case configured to cover the circuit board. The case defines an opening arranged to permit access to the pin connectors of the circuit board and includes a case coupling interface at the opening. A connector housing includes a pin interface configured to receive the pin connectors of the circuit board and a connector housing coupling interface configured to cooperate with the case coupling interface to secure the connector housing to the case over the opening and in cooperation with the pin connectors.

In further features, the connector housing defines a receptacle configured to cooperate with a wiring connector.

In further features, the pin interface is accessible within the receptacle.

In further features, the connector housing coupling interface is at an undersurface of the connector opposite to the receptacle.

In further features, the connector housing coupling interface includes a clip, and the case coupling interface of the case defines a slot configured to receive and retain the clip to secure the connector housing to the case.

In further features, the connector housing coupling interface includes a locator pin, and the case coupling interface of the case defines a pin receptable configured to receive the locator pin therein.

In further features, the connector housing coupling interface includes a tab configured to abut the case when the connector housing is mounted to the case.

In further features, the pin interface of the connector housing defines a plurality of apertures, each one of the plurality of apertures is positioned and sized to receive one of the pin connectors when the connector housing is connected to the case.

In further features, the plurality of apertures are arranged in rows and columns corresponding to rows and columns of the pin connectors of the circuit board.

In further features, the connector housing is a first connector housing and the pin interface is a first pin interface configured to receive the pin connectors in a first pin arrangement; the opening of the case is a first opening, the case further defining a second opening arranged to permit access to a second pin arrangement of the pin connectors on the circuit board that is different from the first pin arrangement; the system further includes a second connector housing including a second pin interface configured to receive the pin connectors of the second pin arrangement, the second pin interface is different from the first pin interface; the case coupling interface is a first case coupling interface and the connector housing coupling interface is a first connector housing coupling interface; the case includes a second case coupling interface at the second opening that is the same as the first case coupling interface; and the second connector housing includes a second connector housing coupling interface that is the same as the first connector housing coupling interface.

In further features, the connector housing is one of a plurality of connector housings each including the connector housing coupling interface and the pin interface; and the connector housing coupling interface of each one of the plurality of connector housings is the same, and the pin interface of each one of the plurality of connector housings is different.

The present disclosure also includes, in various features, a system for housing a circuit board including pin connectors. The system includes: a case configured to cover the circuit board, the case defining a first opening arranged to permit access to a first pin arrangement of the pin connectors of the circuit board and defining a second opening arranged to permit access to a second pin arrangement of the pin connectors of the circuit board, the first pin arrangement and the second pin arrangement are different; a first case coupling interface adjacent to the first opening and a second case coupling interface adjacent to the second opening, the first case coupling interface and the second case coupling interface are the same; a first connector housing including a first pin interface configured to receive the first pin arrangement of the circuit board and a first connector housing coupling interface configured to cooperate with the first case coupling interface; and a second connector housing including a second pin interface configured to receive the second pin arrangement of the circuit board and a second connector housing coupling interface configured to cooperate with the second case coupling interface. The first pin interface and the second pin interface are different, and the first connector housing coupling interface and the second connector housing coupling interface are the same.

In further features, the first connector housing coupling interface and the second connector housing coupling interface each include locator pins and clips.

In further features, the first case coupling interface and the second case coupling interface each define slots configured to receive the clips and receptacles configured to receive the locator pins.

In further features, the first pin interface defines a first plurality of apertures each positioned and sized to receive the pin connectors of the first pin arrangement, and the second pin interface defines a second plurality of apertures each positioned and sized to receive the pin connectors of the second pin arrangement.

The present disclosure also provides for, in various features, a system for housing a circuit board including pin connectors. The system includes: a case configured to cover the circuit board, the case defining an opening arranged to permit access to the pin connectors of the circuit board and including a case coupling interface at the opening; and a plurality of connector housings each including a pin interface and a connector housing coupling interface, the pin interface of each one of the plurality of connector housings is different and the connector housing coupling interface of each one of the plurality of connector housings is the same. The pin interface of at least one of the plurality of connector housings is configured to receive the pin connectors of the circuit board arranged in a first pin arrangement.

In further features, the pin interface of at least one of the plurality of connector housings is configured to receive the pin connectors of the circuit board arranged in a second pin arrangement that is different from the first pin arrangement.

In further features, each one of the plurality of connector housings defines a receptacle configured to cooperate with a connector of a wiring.

In further features, the pin interface is accessible within the receptacle.

In further features, the connector housing coupling interface of each one of the plurality of connector housings includes clips and locator pins, and the case coupling interface defines slots configured to receive the clips and receptacles configured to receive the locator pins.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a case for a circuit board, the case configured to cooperate with a plurality of different connector housings having different pin interfaces;

FIG. 2 is a plan view of the case with a circuit board therein;

FIG. 3 is a cross-sectional view of the case, the circuit board, and connector housings connected thereto;

FIG. 4 is an exploded view of the case separated from the circuit board;

FIG. 5 is a perspective view of an upper area of one of the connector housings;

FIG. 6 is a perspective view of a lower area of the connector housing of FIG. 5;

FIG. 7 is a perspective view of the case with an opening of the case covered by a plug; and

FIG. 8 is a perspective view of an undersurface of the plug.

Corresponding reference numerals indicate corresponding parts throughout the several views of the drawings.

### DETAILED DESCRIPTION

Example embodiments will now be described more fully with reference to the accompanying drawings.

The present disclosure generally includes a case configured to cover a circuit board having any suitable arrangement of pin connectors. The case defines one or more openings through which the pin connectors may be accessed. At each one of the openings is a case coupling interface. The case coupling interfaces are configured to cooperate with coupling members of connector housings. The present disclosure provides for a plurality of different connector housings, which differ with respect to pin interfaces thereof. The pin interfaces are configured to cooperate with the pins of the circuit board. To accommodate a particular arrangement of pins on the circuit board, the connector housing of the plurality of connector housings having the pin interface matching the pins of the circuit board is selected, and then connected to the case at the case coupling interface. Each one of the connector housings has a connector housing coupling interface configured to cooperate with the case coupling interface of the case. The case may thus be used to house any one of a plurality of different circuit boards with various different pin interfaces. Therefore, there is no need to provide a different case for each different circuit board pin configuration.

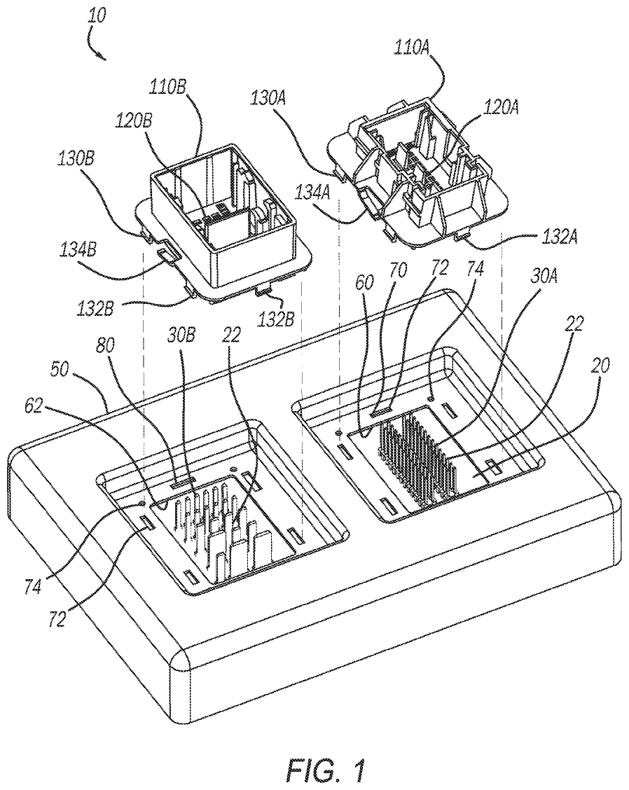

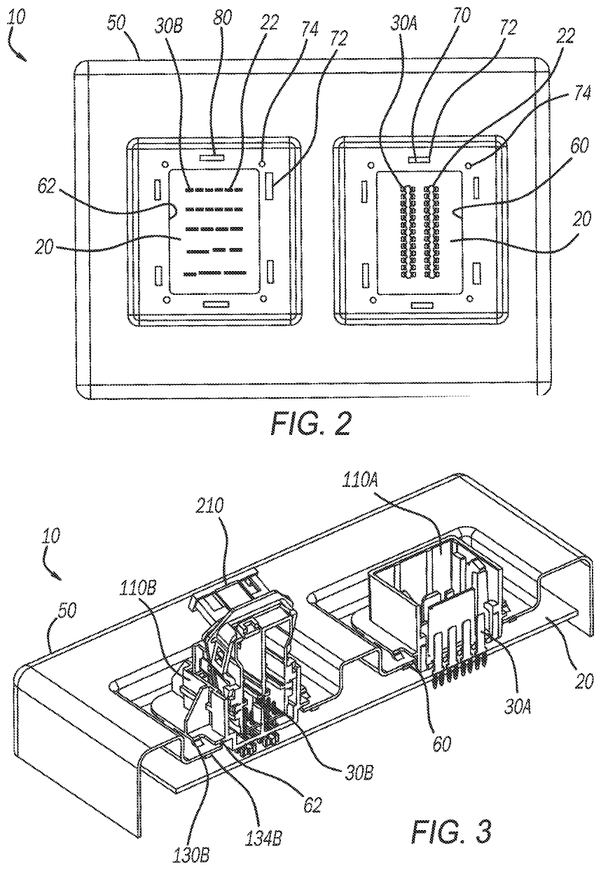

FIGS. 1 and 2 illustrate an exemplary system 10 of the present disclosure for housing a circuit board 20 including pins 22. The circuit board 20 may be configured for use in any suitable application. For example, the circuit board 20 may be, or may be included with, an electronic control unit (ECU) for an automotive application. The circuit board 20 may be configured for use in any suitable non-automotive application as well.

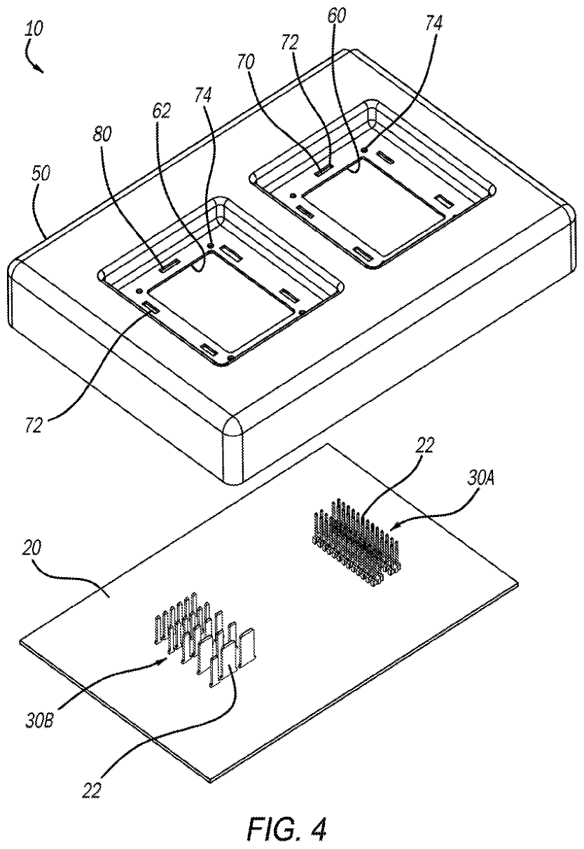

The pins 22 are connector pins arranged in any suitable configuration. For example and as illustrated in FIGS. 1-4, the pins 22 may be arranged in various different rows and columns, and the pins 22 may have various different lengths and widths. For example, the pins 22 may be arranged in a first pin arrangement 30A and a second pin arrangement 30B. With particular reference to FIG. 2, the first pin arrangement 30A includes two columns of pins, which are spaced apart. The second pin arrangement 30B includes five rows of the pins 22 and pins of various different sizes. The pins 22 of the first pin arrangement 30A are generally the same size.

The system 10 further includes a case 50 configured to cover the circuit board 20. The case 50 defines one or more openings arranged to permit access to the pins 22. In the example illustrated, the case 50 defines a first opening 60 and a second opening 62 (see FIG. 2). The first opening 60 is arranged to permit access to the pins 22 of the first pin arrangement 30A. The second opening 62 is configured to permit access to the pins 22 of the second pin arrangement 30B.

At the first opening 60 is a first case coupling interface 70. At the second opening 62 is a second case coupling interface 80, which is identical to the first case coupling interface 70. Each one of the first and second case coupling interfaces 70, 80 includes slots 72 and locator receptacles 74, which are configured to couple any one of the connector housings 110A, 110B, etc. to the case 50.

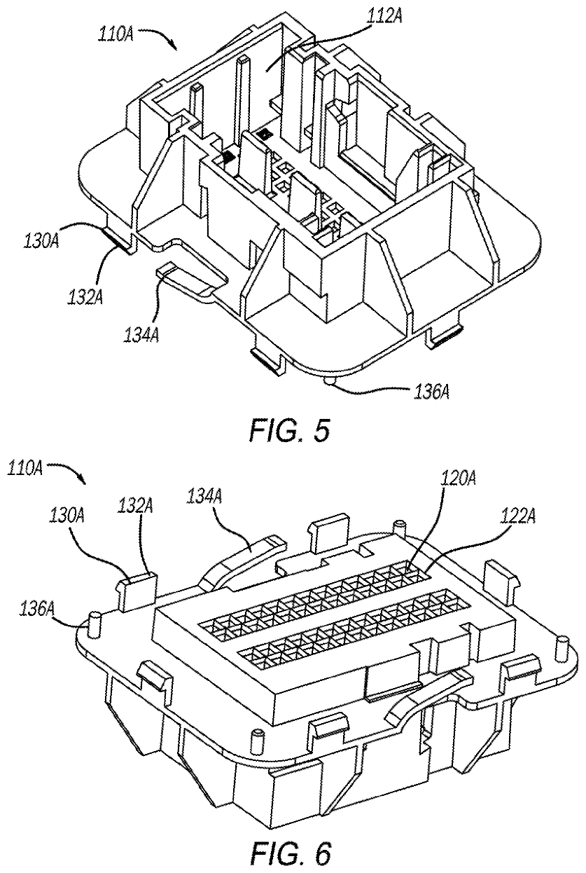

With continued reference to FIGS. 1-4, and additional reference to FIGS. 5 and 6, two exemplary connector housings will be described in detail. A first connector housing is illustrated at reference numeral 110A. The first connector housing 110A defines a receptacle 112A configured to cooperate with any suitable wiring connector. The receptacle 112A is generally at a top surface of the first connector housing 110A. At an undersurface of the first connector housing 110A is a pin interface 120A. The pin interface 120A defines a plurality of apertures 122A. The apertures 122A are sized, shaped, arranged, and otherwise configured to receive the pins 22 of the circuit board 20 therein. In the example illustrated, the pin interface 120A is configured to receive the pins 22 of the first pin arrangement 30A.

The first connector housing 110A further includes a first connector housing coupling interface 130A. The first connector housing coupling interface 130A includes a plurality of clips 132A, tabs 134A, and locators 136A. The clips 132A are sized, shaped, positioned, and otherwise configured to be seated within the slots 72 to couple the first connector housing 110A to the case 50 for cooperation with the first pin arrangement 30A such that the pins 22 extend through the apertures 122A of the pin interface 120A. To facilitate alignment of the first connector housing 110A, the locators 136A are sized, shaped, positioned, and otherwise configured to be seated within the locator receptacles 74. The tabs 134A are flexible tabs, and configured to abut portions of the case 50 defining the first opening 60.

With particular reference to FIGS. 1-3, the system 10 further includes a second connector housing 110B. The second connector housing 110B includes a second connector housing coupling interface 130B, which is the same as, or substantially similar to, the first connector housing coupling interface 130A. The second connector housing coupling interface 130B includes clips 132B, tabs 134B, and locators 136B. The second connector housing coupling interface 130B is configured to cooperate with both the first and the second case coupling interfaces 70, 80 of the case 50. The second connector housing coupling interface 130B includes a second pin interface 120B, which defines a plurality of apertures sized, shaped, positioned, and otherwise configured to receive the pins 22 of the second pin arrangement 30B. FIG. 3 illustrates the second connector housing coupling interface 130B connected to the case 50 at the second opening 62 with the pins 22 of the second pin arrangement 30B extending through the apertures of the second pin interface 120B.

Each one of the first connector housing 110A and the second connector housing 110B are configured to receive connectors 210, which may be any suitable wiring connectors. For example, and with respect to the first connector housing 110, the connector 210 may be seated within the receptacle 112A.

The present disclosure provides for a plurality of different connector housings in addition to the first and second connector housings 110A and 110B. Each one of the additional connector housings includes a connector housing coupling interface, which is the same as, or substantially similar to, the first and second connector housing coupling interfaces 130A, 130B. The additional connector housings also include pin interfaces defining apertures configured to receive the pins 22 of the circuit board 20. The pin interfaces of the additional connector housings are sized, shaped, positioned, and otherwise configured to operate with various pin arrangements that may be present on the circuit board 20 in addition to the pin arrangements 30A, 30B. Based on the pin arrangements of the circuit board 20, any one of the first connector housing 110A, the second connector housing 110B, or any other suitable connector housing including a connector housing coupling interface configured to cooperate with the slot 72 and the locator receptacle 74 may be selected and mounted to the case 50. The present disclosure thus provides for a “universal” case 50 and a plurality of different connector housings 110A, 110B, etc. with various pin interfaces 120A, 120B, etc. configured to cooperate with any suitable pin arrangements 30A, 30B, etc. of the circuit board 20. As a result, there is no need for manufacturing a separate case 50 for each pin arrangement of the circuit board 20.

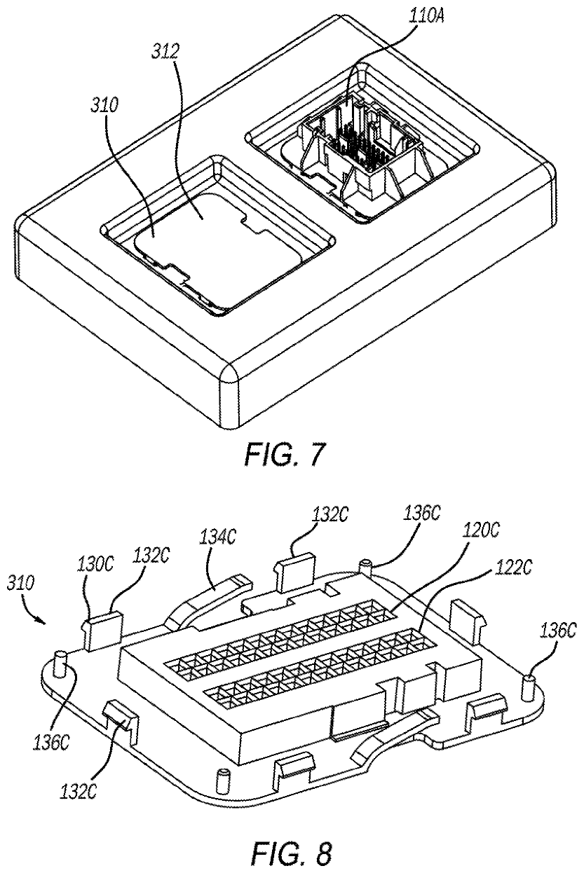

In some applications, one or more of the first opening 60 and the second opening 62 may be plugged when not in use. FIGS. 7 and 8 illustrate an exemplary plug 310, including an outer surface 312, which generally provides a cover. With particular reference to FIG. 8, the plug 310 includes a third connector housing coupling interface 130C, which is the same as, or substantially similar to, the first and second connector housing coupling interfaces 130A, 130B. The second connector housing coupling interface 130C thus includes clips 132C, tabs 134C, and locator pins 136C. The third connector housing coupling interface 130C is configured to cooperate with each of the first case coupling interface 70 and the second case coupling interface 80. The plug 310 further includes a third pin interface 122C defining third apertures 122C. The third pin interface 122C may be arranged in any suitable manner so as to cooperate with the pin arrangement 30A, 30B, etc. to be covered.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A system for housing a circuit board including pin connectors, the system comprising:
a case configured to cover the circuit board, the case defining an opening arranged to permit access to the pin connectors of the circuit board and including a case coupling interface at the opening; and
a connector housing including a pin interface configured to receive the pin connectors of the circuit board and a connector housing coupling interface configured to cooperate with the case coupling interface to secure the connector housing to the case over the opening and in cooperation with the pin connectors.

2. The system of claim 1, wherein the connector housing defines a receptacle configured to cooperate with a wiring connector.

3. The system of claim 2, wherein the pin interface is accessible within the receptacle.

4. The system of claim 2, wherein the connector housing coupling interface is at an undersurface of the connector opposite to the receptacle.

5. The system of claim 1, wherein:
the connector housing coupling interface includes a clip; and
the case coupling interface of the case defines a slot configured to receive and retain the clip to secure the connector housing to the case.

6. The system of claim 1, wherein:
the connector housing coupling interface includes a locator pin; and
the case coupling interface of the case defines a pin receptable configured to receive the locator pin therein.

7. The system of claim 1, wherein the connector housing coupling interface includes a tab configured to abut the case when the connector housing is mounted to the case.

8. The system of claim 1, wherein the pin interface of the connector housing defines a plurality of apertures, each one of the plurality of apertures is positioned and sized to receive one of the pin connectors when the connector housing is connected to the case.

9. The system of claim 8, wherein the plurality of apertures are arranged in rows and columns corresponding to rows and columns of the pin connectors of the circuit board.

10. The system of claim 1, wherein:
the connector housing is a first connector housing and the pin interface is a first pin interface configured to receive the pin connectors in a first pin arrangement;
the opening of the case is a first opening, the case further defining a second opening arranged to permit access to a second pin arrangement of the pin connectors on the circuit board that is different from the first pin arrangement;
the system further includes a second connector housing including a second pin interface configured to receive the pin connectors of the second pin arrangement, the second pin interface is different from the first pin interface;
the case coupling interface is a first case coupling interface and the connector housing coupling interface is a first connector housing coupling interface;
the case includes a second case coupling interface at the second opening that is the same as the first case coupling interface; and
the second connector housing includes a second connector housing coupling interface that is the same as the first connector housing coupling interface.

11. The system of claim 1, wherein the connector housing is one of a plurality of connector housings each including the connector housing coupling interface and the pin interface; and
wherein the connector housing coupling interface of each one of the plurality of connector housings is the same, and the pin interface of each one of the plurality of connector housings is different.

12. A system for housing a circuit board including pin connectors, the system comprising:
a case configured to cover the circuit board, the case defining a first opening arranged to permit access to a first pin arrangement of the pin connectors of the circuit board and defining a second opening arranged to permit access to a second pin arrangement of the pin connectors of the circuit board, the first pin arrangement and the second pin arrangement are different;
a first case coupling interface adjacent to the first opening and a second case coupling interface adjacent to the second opening, the first case coupling interface and the second case coupling interface are the same;
a first connector housing including a first pin interface configured to receive the first pin arrangement of the circuit board and a first connector housing coupling interface configured to cooperate with the first case coupling interface; and
a second connector housing including a second pin interface configured to receive the second pin arrangement of the circuit board and a second connector housing coupling interface configured to cooperate with the second case coupling interface,
wherein the first pin interface and the second pin interface are different, and the first connector housing coupling interface and the second connector housing coupling interface are the same.

13. The system of claim 12, wherein the first connector housing coupling interface and the second connector housing coupling interface each include locator pins and clips.

14. The system of claim 13, wherein the first case coupling interface and the second case coupling interface each define slots configured to receive the clips and receptacles configured to receive the locator pins.

15. The system of claim 12, wherein the first pin interface defines a first plurality of apertures each positioned and sized to receive the pin connectors of the first pin arrangement, and the second pin interface defines a second plurality of apertures each positioned and sized to receive the pin connectors of the second pin arrangement.

16. A system for housing a circuit board including pin connectors, the system comprising:
a case configured to cover the circuit board, the case defining an opening arranged to permit access to the pin connectors of the circuit board and including a case coupling interface at the opening; and
a plurality of connector housings each including a pin interface and a connector housing coupling interface, the pin interface of each one of the plurality of connector housings is different and the connector housing coupling interface of each one of the plurality of connector housings is the same,
wherein the pin interface of at least one of the plurality of connector housings is configured to receive the pin connectors of the circuit board arranged in a first pin arrangement.

17. The system of claim 16, the pin interface of at least one of the plurality of connector housings is configured to receive the pin connectors of the circuit board arranged in a second pin arrangement that is different from the first pin arrangement.

18. The system of claim 16, wherein each one of the plurality of connector housings defines a receptacle configured to cooperate with a connector of a wiring.

19. The system of claim 18, wherein the pin interface is accessible within the receptacle.

20. The system of claim 16, wherein:
the connector housing coupling interface of each one of the plurality of connector housings includes clips and locator pins, and
the case coupling interface defines slots configured to receive the clips and receptacles configured to receive the locator pins.
